(19) United States
(12) Patent Application Publication
(10) Pub. No.: US 2005/0207356 A1
(43) Pub. Date: Sep. 22, 2005

(54) Stand-alone device for determining communication parameters and channel configuration of an asynchronous serial channel using a user determined methodology

(76) Inventors: Lawrence C. Gross JR., Pullman, WA (US); David G. Bogut, Pullman, WA (US)

Correspondence Address: LIEBLER, IVEY, CONNOR, BERRY & ST. HILAIRE;The Edison Professional Building, 1141 North Edison, Suite C, P.O. Box 6125, Kennewick, WA, 99336-0125, US

(21) Appl. No.: 10/803,019

(22) Filed: Mar. 17, 2004

(51) Int. Cl. H04L 12/16

(52) U.S. Cl. 370/260

(57) ABSTRACT

A computer program controlled microprocessor enables the user to create scripts which are used as input to asynchronous serial devices to prompt the serial device to transmit communication parameters to DTE and DCE drivers which communicate via UART and pulse width detectors with the microprocessor allowing determination and display of communication parameters including Baud Rate and other such communication parameters.

### FIELD OF THE INVENTION

The present invention relates generally to communications transmitted by devices with asynchronous serial channels. In particular, it relates to determining the parameters and configuration of any of these devices.

### BACKGROUND OF THE INVENTION

Many industries now use microprocessor-based devices to measure, calculate, and respond to various electrical, mechanical, and chemical systems. These devices typically use asynchronous serial communication channels as a method to program the device, permanently report data to another location, or provide local temporary access to the information in the device. These devices are found in almost all industries. An example, and initial application of the invention, is for use by technicians to determine the parameters and configuration of a serial channel before connecting their computer or other device for testing, permanent connection, or troubleshooting of the device.

The user often may change the communication parameters and configuration of a device. The parameters and configuration matters of interest include the baud rate (ranging from 300 to 230,400), number of data bits (7 or 8), type of parity (none, even, or odd), and channel configuration standard (none, data terminal equipment—DTE, or data communications equipment—DCE). The parameters and configuration often are initially set to a value by the equipment manufacturer. Sometimes the user does not know the parameters or the configuration, or the parameters or configuration were later changed to a value unknown by the present user. If the user needs to connect a computer or other equipment to the device using the specific parameters and configuration, they typically determine the parameters by manual trial and error by changing the parameters within the connected device software or hardware, or changing the cable connections to match the channel configuration.

The present invention is a tool that is pre-programmed by the user to automatically detect the asynchronous serial channel parameters and configuration and report them on a display, LED, LCD, or other method of user interface. The user then uses this information to configure the parameters within the connected device software or hardware, or changing the cable connections to match the channel configuration.

This makes the setup of the asynchronous serial communication channel between two devices quicker for the user.

### SUMMARY OF THE INVENTION

The invention has two aspects: software and hardware. The software allows user defined scripts to be stored in the hardware memory. The hardware is then connected to a device through the serial port connector(s). A script is selected by the user via a switch. Once powered on and the start button is pressed the software controls the hardware to run the user defined script to determine the communication parameters and configuration, and display them on the user interface display.

The hardware is comprised of typical circuits used in microprocessor-based systems to communicate using an asynchronous serial communication channel. In addition, the invention includes a pulse width detector. The invention comprises a method for power, a microprocessor, a UART, DTE and DCE serial drivers, user interface buttons, switches, and indicators. The power turns on the microprocessor that drives all of the other parts of the hardware. The communication is transmitted and received via the port connectors.

The software is comprised of two modes: learn mode and normal mode. While in learn mode the invention is configured (scripts are stored) for the users applications or devices. While in normal mode the device determines the communication parameters of baud rate, number of data bits and parity type, and configuration standard of DTE or DCE.

The invention will work with many different devices, including for example, as will be recognized by those of ordinary skills in the electronic arts, a microprocessor based protective relay, a remote terminal unit (RTU) for supervisory control and data acquisition systems, a programmable logic controller (PLC), or a microprocessor based industrial measurement device as configured by the user in learn mode. The user selects the desired device while in normal mode before pressing the start button. The user selects a device using a multiple position switch or other user interface method. After the start button is depressed, the invention goes through a series of steps attempting communication with the connected device. The data transmitted to—and the data expected in return from—the connected device, are determined by user-defined scripts for each device. The scripts are programmed into the invention by the user while in learn mode. The scripts are developed by the user as needed or a pre-developed script is selected from within the software. As the scripts are performed at different baud rates using different communication parameters, the invention also measures the pulse width of each data bit received from the connected device. Based on this pulse width the invention can rule-out certain baud rates as viable communication parameters. For example if the minimum pulse width measured is 50 microseconds for a single pulse (bit) then the effective baud rate (bit per second) is 1/(0.00005+/−10%)=19200 bits per second (19200 baud). This invention uses a 10% margin of error, but other margins of error could be used effectively. This allows the invention to proceed with other baud rate possibilities. It is possible to get two bits sequentially at a higher baud rate. For example, a 50 microsecond pulse may actually be 2 sequential bits at 38,400 bits per second. In this case the invention determines the 19,200 rate (skipping all other rates less than 19,200). When the 19,200 is not verified by the script, it attempts to verify the next highest rate, which in this case would be 38,400. The script will then verify that this is the correct baud rate. The correct baud rate may always be higher than the pulse width detection method, but never less.

Once the communication parameters and configuration are determined, the invention displays the results (baud rate, data bits, parity, and configuration—DTE, DCE) on a user interface such as LEDs, an LCD, or other display.

### BRIEF DESCRIPTION OF DRAWINGS

FIG. 1A is a block diagram representation of the normal mode of operation of the invention showing the invention (800) in the operating mode interconnected with the device for which parameters and characteristics are to be determined.

FIG. 1B is a block diagram representation of the learn mode of the invention illustrating the mode allowing the user to program scripts specific to the users needs.

FIG. 2 is a block diagram of the hardware of one embodiment of the invention.

FIG. 3 is a flow diagram of the software of one embodiment of the invention.

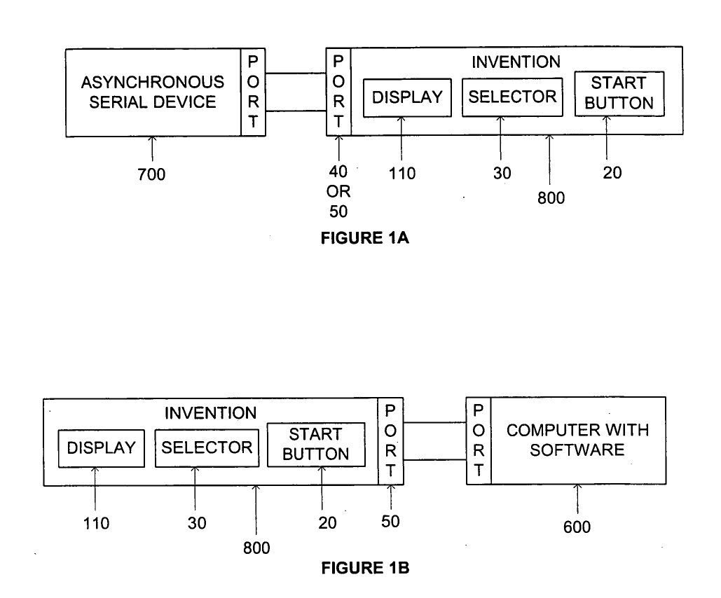

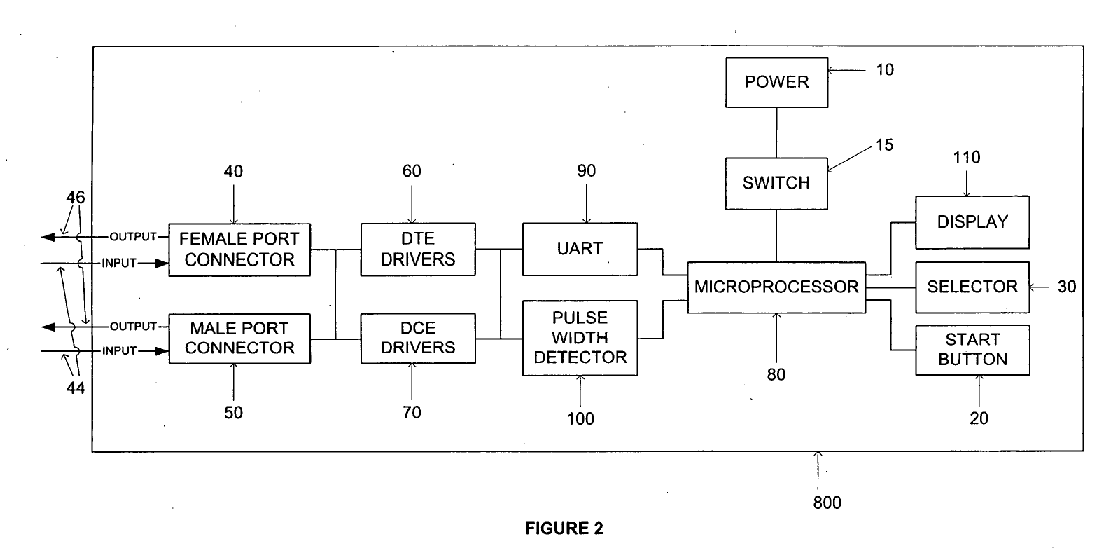

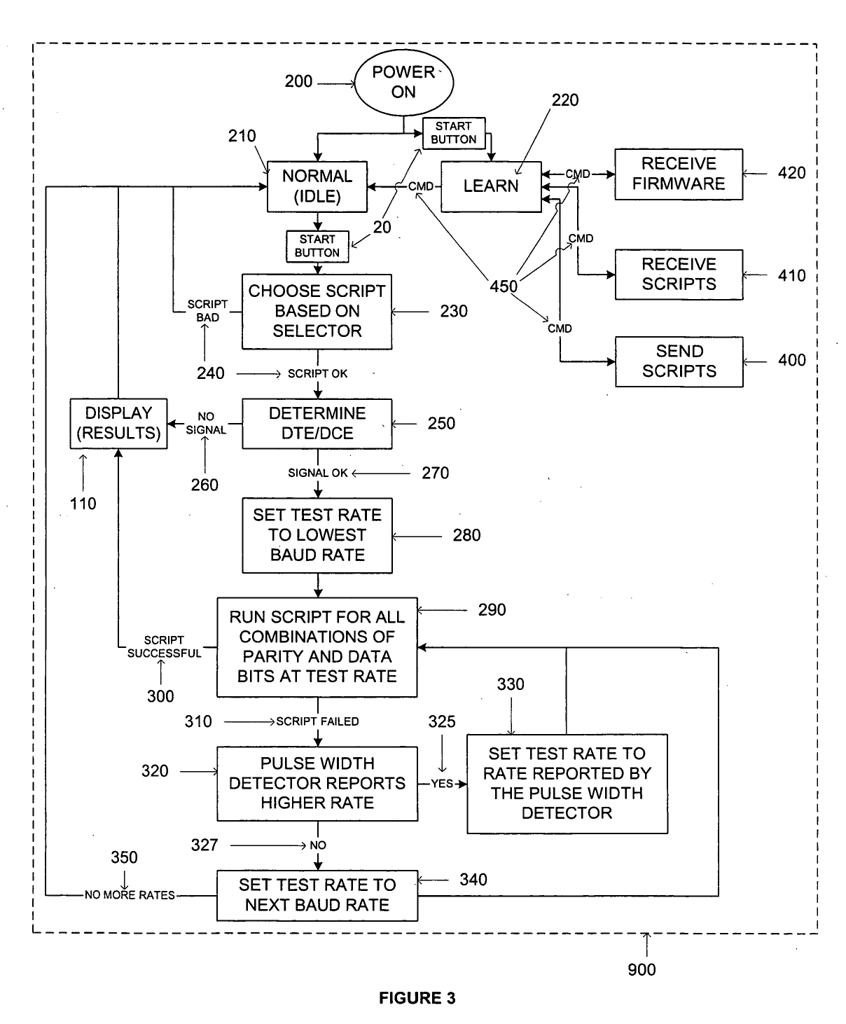

### DETAILED DESCRIPTION OF THE INVENTION

The invention hardware is a combination of common electronic and electrical circuits, where each provides a function by means understood by those of ordinary skill in electrical engineering. The interrelationship of these circuits, however, is unique.

The power (10) for the preferred embodiment is typically three volts and will generally be provided by two AAA cell batteries. Other power sources may be, but are not limited to an AC adapter, solar cell, serial communication port powered, externally DC powered, and others that will readily be appreciated by those of ordinary skills in the electronic arts. The power source must be compatible with the selected hardware per typical electrical engineering practice, which may include some method of voltage regulation. The switch (15) provides a method by means understood by those of ordinary skill in electrical engineering to remove power as necessary as determined by the functional design. When the switch (15) is turned on or power is provided by other means, the microprocessor (80) and associated circuitry is powered up.

The start button (20) and the selector switch (30) provide the user interface for input into the invention. The female (40) or male (50) port connectors provide the input (44) and output (46) exchange between the invention (800) and the connected device. The start button (20) is used to begin the parameter detection process for the connected device or if it is held down while the invention powers up, the invention will be in Learn (220) mode. Other methods for placing the invention in Learn (220) mode are possible and would be another embodiment of this invention as recognized by those of ordinary skills in the electronic arts.

The female (40) and male (50) serial channel port connectors are provided, in the preferred embodiment, by 9-pin D subminiature connectors but may be provided by other connector means as will be appreciated by those of ordinary skills in the electronic arts. One is female (40) and one is male (50) to allow connection to devices that have either female or male ports on them. Having two ports allows the invention to be connected in the middle of a communication channel between two communicating devices. In this connection the invention can determine communication parameters of the communication between the two devices. Another embodiment of the invention would be to exclude this pass-through embodiment and only have one communication port connector.

Asynchronous serial communication channel configuration is provided by driver means including what is recognized in the industry as the two standards of DTE (60) and DCE (70). To determine how to communicate on the device channel, a communicating device must have the appropriate configuration. The two hardware drivers are included in the invention, a DTE driver (60) and a DCE driver (70). These drivers provide means for communicating using the corresponding standard. The device or details of the drivers and their equivalents are by means understood by those of ordinary skill in the electronic arts. The invention determines which driver to use as part of its process described below.

The microprocessor (80) controls the system. Any microprocessor or sub-circuit selected by means understood by those of ordinary skill in electrical engineering can provide the control when provided the appropriate software. The microprocessor (80) of the preferred embodiment is the Atmel ATMega16 which includes a UART (90) to provide the communication by communication means understood by those of ordinary skill in electrical engineering. Communication is received as an input (44), from the device being tested, at the port connectors (40, 50) in RS-232 format (an industry standard), and is converted to logic level voltage by the appropriate driver comprising either DTE (60) or DCE (70) and interpreted into a data format for the microprocessor (80) by the UART (90) by means understood by those skilled in electrical engineering, the pulse width detector (100) tells the microprocessor the width of any data bit by a pulse width measurement means including the number of clock samples, at an 8 kHz sample rate for this embodiment, while the pulse exists, and other pulse width measurements as will be understood by those of ordinary skill in electrical engineering.

The invention sends communication to the connected device as an output (46) through one of the ports (40 or 50) based on scripts loaded in the microprocessor (80) memory via the Learn (220) mode. The communication is controlled by the microprocessor (80) that controls the UART (90) and drivers (60,70). Once the scripts are completed the microprocessor controls the display (110) to inform the user of the detected communication parameters and configuration.

Typical parameters determined but not limited to, are baud rate, data bits, parity, and the configuration (DTE versus DCE). The invention may be programmed to display one or all of these parameters. A different embodiment of the invention may include stop bits as well.

Any two or more of these components (10 through 110) may be combined into one component, chip, or system as a different embodiment of the invention. For example, a typical microprocessor may include a UART (90) and/or a pulse width detector (100) as part of a single electronic chip.

The invention software is a combination of programming methods, where each provides a function by means understood by those of ordinary skill in embedded systems programming. The interrelationship of these methods, however, is unique. The software allows the user to define the necessary communication that is ultimately sent to the interrogated device via the script. It outputs this communication to the connected device using varied communication parameters. If the connected device responds with a recognizable response per the user defined script, then the communication parameters were correct.

The invention starts its process when it is powered on (200) by applying power (10) via the switch (15). As the invention powers on (200) it will go to one of two modes, Normal (210) or Learn (220) mode. If while powering on (200) the start button (20) is depressed the invention goes into Learn (220) mode, otherwise it goes into Normal (210) mode.

While in Learn (220) mode the invention may be connected to a personal computer to allow the invention to send (400) or receive (410) user defined scripts from or to the connected computer (600) running the necessary software (600) developed by means understood by those of ordinary skill in computer programming. The computer (600) serial port is connected to one of the port connectors (40,50) of the invention. Another function of the Learn (220) mode is to allow the download of new firmware to the invention. This is provided for future upgrades as needed by means known to those of ordinary skill in embedded systems programming. Each of these tasks (400, 410, and 420) is initiated by a command (450) sent by the computer and software (600). When the invention is configured, the computer and software send a command (450) to make the invention return to Normal (210) mode.

The primary use of the invention is while in Normal (210) mode. While in Normal (210) mode the invention remains idle displaying the most recent communication parameters and indicating that it is ready via the Display (110) until the Start Button (20) is pressed.

To use the invention, it is connected to the asynchronous serial device (700) that is to be interrogated by connecting at least one port connector (40 or 50) to the device (700) directly or through a connecting cable. When the Start Button (20) is pressed the invention selects the appropriate script (230) based on the Selector (30) position established by the user. The selector (30) switch in one embodiment of the invention is an eight position rotary switch. Other embodiments may include but are not limited to more or less position switches, dip switches, or buttons. Error checking (240) is performed on the script to verify that it is acceptable and has not been corrupted. Then the invention checks for a DTE or DCE standard (250) signal, by testing each of the appropriate signal input (44) and output (46) lines connected to the device being interrogated. If a signal exists (270), then the invention determines if the connected device is using the DTE or DCE standard (250) and the result of this signal is displayed (20). If there is not a signal or the signal is non-standard the invention reports that a signal is not found (260) to the display (110). These signals go through the hardware conversion and interpretation process, as stated above, so that the microprocessor can determine the proper DTE or DCE application.

If a signal exists (270) the invention sets the baud rate of the test to the lowest value (280), typically 300 baud, and begins the selected script (290) for all combinations of parity and data bits at the test baud rate based on the user configuration of the script.

If the script is successful (300) it is an indication that the communication parameters were correct for the tested parameters and the results are displayed (110). A typical script would include sending a communication to the device (i.e. carriage return) and waiting for an appropriate response as determined by the user (i.e. an ASCII character prompt). If the appropriate response is detected then the current baud rate, data bits, and parity are considered correct.

As communication (i.e. an ASCII character prompt) is received from the connected device (700) the pulse width detector (100) reports the widths of each pulse. For example, if the device response (input to the invention—44) is the ASCII character “Q” at a rate of 38400 bits per second. The invention would respond as follows:

| | Bit Stream from the | | | | | | |
|---|---|---|---|---|---|---|---|
| | interrogated device | | | | | | |
| | based on the | | | | | | Pulse width |
| Communication | ASCII character “Q” | | | | | | detection |
| Parameters | Start | | Parity | Stop | Number of “1” bits | Minimum pulse | Rate in bits |
| (Parity, Data Bits) | Bit | Data Bits | Bit | Bit | in sequence (pulse) | width in seconds | per second |
| None, 8 | 1 | 10001100 | NA | 0 | 2 | 0.000052 sec | 19,200 |
| None, 7 | 1 | 1000110 | NA | 0 | 2 | 0.000052 sec | 19,200 |
| Odd, 8 | 1 | 10001100 | 0 | 0 | 2 | 0.000052 sec | 19,200 |
| Odd, 7 | 1 | 1000110 | 0 | 0 | 2 | 0.000052 sec | 19,200 |
| Even, 8 | 1 | 10001100 | 1 | 0 | 1 | 0.000026 | 38,400 |
| Even 7 | 1 | 1000110 | 1 | 0 | 1 | 0.000026 | 38,400 |

If the minimum pulse width detected is less than half of what is indicated by the maximum baud rate of 230,400 the pulse is considered noise and ignored. Otherwise the minimum pulse width indicates certain baud rates do not need to be tested because they cannot generate such a pulse width.

If the script fails (310) and the pulse width detector (100) indicates that the data is being transmitted at a higher rate (320, 325) than the present test, the invention shifts the baud rate to this higher baud rate (330) and runs the script again (290). The higher baud rate is the lowest possible baud rates as indicated by the pulse width detector (100) as determined by taking the inverse of the pulse width which is described in the Summary of the Invention.

If the script fails (310) and the pulse width detector (100) does not indicate that the data is being transmitted at a higher rate (320, 327) than the present test, the invention shifts the baud rate to the next higher baud rate (340) that is available and runs the script again (290).

This process is repeated until the script is successful (300) or there are no more rates to try (350).

1. A stand-alone device for determining communication parameters and channel configuration of an asynchronous serial device comprising:
a. at least one microprocessor having at least one connector means; at least one DTE Driver and or at least one DCE Driver receiving inputs from the said at least one connector means and providing outputs to said at least one connector means; the said at least one DTE Driver and or at least one DCE Driver having outputs to at least one UART and or at least one pulse width detector; the said at least one DTE Driver and or at least one DCE Driver receiving inputs from the said at least one UART and or the said at least one pulse width detector; the said at least one UART and or the said at least one pulse width detector providing outputs to and receiving inputs from the at least one microprocessor;
b. the at least one microprocessor having memory; the memory receiving from the at least one connector means at least one computer program script; at least one display means receiving input from the at least one microprocessor; power means for operation of the microprocessor;
c. the at least one microprocessor communicating with or interrogating with the at least one computer program script, by the at least one connector means, at least one asynchronous serial device;
d. the at least one microprocessor receiving or not receiving, by the at least one connector means, a signal from the at least one asynchronous serial device; the signal or no signal from the at least one asynchronous serial device is detected by either the at least one DTE Driver or the at least one DCE Driver; the output from either the at least one DTE Driver or the at least one DCE Driver is communicated to the at least one UART and the at least one pulse width detector; the output from the at least one UART and the at least one pulse width detector is communicated by electronic means to the at lease one microprocessor; if a signal exists (270) then the at lease one microprocessor displays the at the at least one display; if there is not a signal or the signal is non-standard then the at least one microprocessor displays that a signal is not found (260) at the at least one display (110);
e. if a signal exists (270) the computer program script operates the microprocessor to set the baud rate of the test to the lowest value (280) and begins the selected script (290) for all combinations of parity and data bits at the test baud rate based on the user configuration of the script; if the script is successful (300) it is an indication that the communication parameters were correct for the tested parameters and the results are displayed (110); if the appropriate response is detected then at least one microprocessor displays the current baud rate, data bits, and parity and the baud rate, data bits and parity are considered correct
f. as communication (i.e. an ASCII character prompt) is received from the connected device (700) the pulse width detector (100) reports the widths of each pulse; if the minimum pulse width detected is less than half of what is indicated by the maximum baud rate of 230,400 the pulse is considered noise and ignored; if the script fails (310) and the pulse width detector (100) indicates that the data is being transmitted at a higher rate (320, 325) than the present test, the computer program script operates on the microprocessor to shift the baud rate to the higher baud rate (330) and operate the script again (290); if the script fails (310) and the at least one pulse width detector (100) does not indicate that the data is being transmitted at a higher rate (320, 327) than the present test, the computer program script operates the microprocessor to shift the baud rate to the next higher baud rate (340) that is available and runs the script again (290); this process is repeated until the script is successful (300) or there are no more baud rates to try (350);
g. when the script is successful (300) and the baud rate is determined the at least one microprocessor operates the at least one display to display the baud rate and or associated communication parameters.
